(19) United States
(12) Patent Application Publication
(10) Pub. No.: US 2009/0095615 A1
(43) Pub. Date: Apr. 16, 2009

(54) UNIVERSAL LIGANDS FOR THE ISOTOPE SEPARATION OF ELEMENTS

(76) Inventors: Edward J. Lahoda, Pittsburgh, PA (US); David L. Stucker, Irmo, SC (US)

Correspondence Address: WESTINGHOUSE ELECTRIC COMPANY, LLC, P.O. BOX 355, PITTSBURGH, PA, 15230-0355, US

(21) Appl. No.: 11/870,708

(22) Filed: Oct. 11, 2007

(51) Int. Cl. B01D 59/34

(52) U.S. Cl. 204/157.22; 204/157.2

(57) ABSTRACT

The present invention is directed to a method of isotope separation of one or more isotopes of a metal having a valence of two or more, comprised of selecting a ligand, such as BH₄, BD₄, CH₃BH₃ or CD₃BD₃, for attachment to one or more isotopes of the metal, ionically attaching the ligand to the one or more isotopes of the metal, and separating the one or more isotopes of the metal by an isotope separation technique. Suitable isotope separation techniques that can be used in the methods of the present invention include centrifuge, gaseous diffusion, gaseous distillation or molecular laser isotope separation techniques.

### BACKGROUND OF THE INVENTION

1. Field of the Invention

The present invention relates to methods for isotope separation of elements. More particularly, the present invention relates to methods of isotope separation of elements that employ attachment of ligands to the elements, which allows for the isotopic separation of a large number of elements as well as an increase in the efficiency and cost-effectiveness of the isotope separation.

2. Description of the Prior Art

Isotope separation has been limited in practice to a few elements due to the fact that the methods commonly available, such as centrifuge or diffusion, require a stable, volatile feed material. The use of laser isotope separation techniques, such as Molecular Laser Isotope Separation (MLIS) and Atomic Vapor Laser Isotope Separation (AVLIS), provides even more limitations.

For example, the MLIS approach not only requires volatile, stable isotopic compounds, but also requires compounds that possess absorption bands which are isotopically active in order to work.

The AVLIS approach eliminates the need for stable volatile compounds but has difficulty in making a product that can readily be separated when activated. Additionally, AVLIS operations usually require at least two colors of operation, i.e., IR as well as UV wavelength, which greatly increases the cost of production as well as introduces technical issues with respect to timing and product separation. Typically, the cost of AVLIS separations is much higher than MLIS separations

In addition, before isotope separation can be performed, the usual development path requires a long range screening program to identify candidate molecules that meet the requirements of the separation technology used. This approach dramatically increases the risks and costs associated with developing and implementing any type of isotope separation process.

### SUMMARY OF THE INVENTION

Accordingly, it is an object of the present invention to provide efficient, effective, economical methods for isotope separation of elements; i.e. metals.

It is another object of the present invention to provide methods for isotope separation that can be used on a large number of metals.

It is a further object of the present invention to provide methods that allow for the separation of metals in which stable, volatile feed material compounds can be separated.

The aforementioned objectives are met by the present invention, which provides methods of isotope separation of one or more isotopes of a metal, comprised of selecting a ligand for attachment to one or more isotopes of the metal, chemically attaching the ligand to the one or more isotopes of the metal, and separating the one or more isotopes of the metal by an isotope separation technique.

The methods of the present invention can be performed on isotopes of any metal having a valence of three or more. Upon attachment of the ligand to the one or more isotopes of a metal, the metal-ligand forms a volatile, stable complex in which separation of the isotopes of the metal can be performed.

Suitable ligands that are used in the methods of the present invention include, without limitation, boron-containing ligands, such as BH₄, BD₄, CH₃BH₃ or CD₃BD₃.

Suitable isotope separation techniques that can be used in the method of the present invention include, without limitation, gas centrifuge, gaseous diffusion, gaseous distillation or molecular laser isotope separation techniques.

### DESCRIPTION OF THE PREFERRED EMBODIMENTS

The present invention provides methods of isotope separation of one or more isotopes of a metal, comprised of selecting a ligand for attachment to the one or more isotopes of the metal, chemically attaching the ligand to the one or more isotopes of the metal, and separating the one or more isotopes of the metal by an isotope separation technique.

The methods of the present invention can be performed on isotopes of any metal having a valence of three or more. Upon attachment of the ligand to the one or more isotopes of a metal, the metal-ligand forms a volatile, stable complex in which separation of the isotopes of the metal can be performed.

Suitable ligands that are used in the methods of the present invention include, without limitation, boron-containing ligands, such as BH₄, BD₄, CH₃BH₃ or CD₃BD₃.

Suitable isotope separation techniques that can be used in the methods of the present invention include, without limitation, gas centrifuge, gaseous diffusion, gaseous distillation or molecular laser isotope separation techniques. Such isotope separation techniques are well known in the art and are exemplified in U.S. Pat. No. 6,726,844; U.S. Pat. No. 4,487,629; U.S. Pat. Nos. 5,591,947; and 6,202,440.

In an embodiment of the present invention, isotope separation of a metal is performed by selecting a ligand, attaching the ligand to the metal and using molecular laser isotope separation to separate the isotopes of the metal.

The ligand is selected based on its vibrational frequency so that the metal-ligand bond or a boron bond within the ligand has an absorption wavelength that is close to the emission wavelength of the laser used in the molecular laser isotope separation technique so that little emission tuning of the laser is required.

The ligands of the present invention are large enough in conformation so as to surround a metal completely, resulting in a metal-ligand complex that has a neutral charge with no dipole, and thus is volatile. Ligands that are too large compared to the metal results in a metal not reacting fully with the ligand because of steric hindrance. Incomplete reaction with the ligand results in a metal-ligand-halide complex that has a dipole which results in the complex lacking volatility.

The ligand is selected based on the ligand's vibrational frequency so that the ligand has an absorption wavelength that is close to the emission wavelength of the laser used in the molecular laser isotope separation technique. The closer the absorption wavelength of the ligand to the emission wavelength of the laser, the less need there is for tuning the laser to the proper emission wavelength, which enhances the efficiency of isotope isolation.

The present invention is more particularly described in the following non-limiting examples, which are intended to be illustrative only, as numerous modifications and variations therein will be apparent to those skilled in the art.

### EXAMPLE 1

### General Reaction of a Multivalent Metal with —BH₄ or —BD₄

A metal halide is reacted with a lithium borohydride compound to form a metal-borohydride complex and a lithium halide salt.

The chemical structure of a lithium-BH₄ complex is the following:

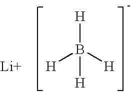

The boron atom forms a hybridized orbital structure similar to CH₄.

BD₄ may be used in place of BH₄ to produce a metal-borodeuterium complex.

The reactions are illustrated below.

M^{+x}Zₓ+xLiBH₄→M(BH₄)ₓ+xLiZ

M^{+x}Zₓ+xLiBD₄→M(BD₄)ₓ+xLiZ

where M=metal;

Li=lithium (sodium may be substituted here for lithium);

Z=chlorine, fluorine, iodine or bromine;

x=valence of metal, in which valence is >2.

### EXAMPLE 2

### General Reaction of Multivalent Metal with —BH₃CH₃ or —BD₃CH₃

A metal halide is reacted with a lithium methylborolhydride compound to form a metal-methylborohydride complex and a lithium halide salt.

M^{+x}Zₓ+xLiBH₃CH₃→M(BH₃CH₃)ₓ+xLiZ

M^{+x}Zₓ+xLiBD₃CH₃→M(BD₃CH₃)ₓ+xLiZ

where M=metal

Li=lithium (sodium may be substituted here for lithium)

Z=chlorine, fluorine, iodine or bromine

x=valence of metal, in which valence of metal is >2.

### EXAMPLE 3

### Calculation of Isotope Shift and Baseline Vibration for Zirconium-BH₄ and Zirconium-BD₄ Complexes

The following indicates the general type of scoring calculations that would be carried out to determine what ligand would be used for each metal. Typical CO₂ lasers have an infrared emission wavelength ranging from about 800-1600 cm⁻¹.

In general, calculation for a two-bodied vibration is the following (for Δv=1 i.e., one energy level shift or v=one quantum) (Note: two-bodied calculations are used instead of n^{th} spring-bodied calculations for ease of explanation):

$$Δɛ = \frac{1}{2 π C} \sqrt{\frac{κ}{μ}}$$

where Δε=energy change (when Δv=1; i.e., one energy level shift;

v=one quantum)

k=effective spring constant (dynes/cm)

μ=reduced mass (g)

C=speed of light (cm/sec)

The metal-BH4 complex can be shown as follows:

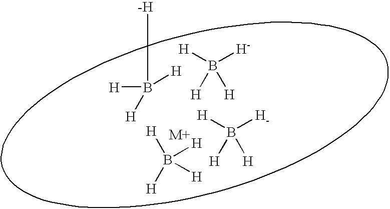

wherein the atoms within the circle=W₁ and the H atom outside the circle is W₂, and
where W=mass;

M=Zirconium (Zr)

Thus, this illustration shows a metal (Zr) ionically bonded to four BH₄ molecules.

The calculation for a two-bodied vibration for the Zr—BH₄ complex is the following:

The atomic mass unit (amu) of Zr=90 (base amu);

the amu of a Zr isotope=91;

The amu for BH4=15

The wavelength shift between the base Zr and the Zr isotope is calculated as follows:

$$wavelength shift = {Δɛ}_{90} - {Δɛ}_{91} = \frac{\sqrt{κ}}{2 π C} ( \frac{1}{\sqrt{{μ}_{90}}} - \frac{1}{\sqrt{{μ}_{91}}} )$$

$${μ}_{90} = \frac{W 1 \times W 2}{W 1 + W 2} ;$$

$$where \text{:} W 1 = 15 \times 3 + 90 + 3 + 11 = 149 ;$$

$$W 2 = 1 ;$$

$$therefore \text{:} {μ}_{90} = \frac{149 \times 1}{149 + 1} = .99333$$

$$and {μ}_{90} = \frac{150 \times 1}{150 + 1} = .99338$$

The effective spring constant (k) for B—H is ≈5×10⁵ dyne/cm.

$$wavelength shift = \frac{3.75 \times {10}^{- 9}}{\sqrt{1.66 x {10}^{- 24}}} ( \frac{1}{.99666} - \frac{1}{.99338} ) \\ = 2.91 \times {10}^{3} ( 2.47 \times {10}^{- 5} ) = 0.072 {cm}^{- 1}$$

Thus, for Zr with an amu=90 the

$${Δɛ}_{90} = 2.91 \times {10}^{3} ( \frac{1}{.99666} ) = 2920 {cm}^{- 1}$$

This is the absorption wavelength for the base Zr₉₀ metal.

Thus, the absorption wavelength for the isotope Zr₉₁ metal is 2920 cm⁻¹+0.072=2920.072 cm⁻¹.

Based on these calculations, the emission wavelength of the laser needs to be close to approximately 2920 cm⁻¹ and no wider than 0.072 cm⁻¹ so that it can effectively isolate the two Zr isotopes.

Calculation of the wavelength shift and absorption wavelength of the ligand BD₄ is as follows:

$${μ}_{90} = \frac{164 \times 2}{164 + 2} = 1.97590$$

$${μ}_{91} = \frac{165 \times 2}{165 + 2} = 1.97605$$

$$wavelength shift = 2.91 \times {10}^{3} ( \frac{1}{\sqrt{1.9759}} - \frac{1}{\sqrt{1.97605}} ) \\ = 0.0775 {cm}^{- 1}$$

Thus, for Zr with an amu=90 the

$${Δɛ}_{90} = 2.91 \times {10}^{3} ( \frac{1}{\sqrt{1.9759}} ) = 2063 {cm}^{- 1}$$

Thus, the absorption wavelength for the isotope Zr₉₁ metal is 2063 cm⁻¹+0.0775=2063.0775.

Based on these calculations, the emission wavelength of the laser needs to be close to approximately 2063 cm⁻¹ and no wider than 0.0775 cm⁻¹ so that it can effectively isolate the two Zr isotopes.

### EXAMPLE 4

### Calculation of Second Isotope Shift and Baseline for Zr—BH₄ and Zr—BD₄

Where amu for M (Zr)=90 and amu for ligand (BH₄)=15:

$$μ = \frac{( 90 + 45 ) \times 15}{15 + 135} = 13.5$$

$${ɛ}_{90} = 2.91 \times {10}^{3} ( \frac{1}{\sqrt{13.5}} ) = 792 {cm}^{- 1}$$

$$The wavelength shift for {Zr}_{90} to {Zr}_{91} = ( \frac{1}{\sqrt{13.5}} - \frac{1}{\sqrt{13.6}} ) \\ = 0.291 {cm}^{- 1}$$

Where amu for M (Zr)=90 and amu for ligand (BD₄)=19:

$$μ = \frac{( 90 + 57 \times 19 )}{19 + 147} = 16.83$$

$${ɛ}_{90} = 2.91 \times {10}^{3} ( \frac{1}{16.83} ) = 709 {cm}^{- 1}$$

$$The wavelength shift for {Zr}_{90} to {Zr}_{91} = ( \frac{1}{\sqrt{16.83}} - \frac{1}{\sqrt{16.84}} ) \\ = 0.274 {cm}^{- 1}$$

### EXAMPLE 5

### Determination of Ligand Molecular Weight (amu) for a Particular Laser

$$v = \frac{\sqrt{k}}{2 π 3 \times {10}^{10} \sqrt{1.66 \times {10}^{- 24}}} ( \frac{1}{\sqrt{μ}} )$$

where v=vibrational frequency of a laser

Solve for μ:

$$μ = {( \frac{ν}{κ} 2 π ( 3 \times {10}^{10} ) ( \sqrt{1.66 \times {10}^{- 24}} ) )}^{2}$$

$$μ = \frac{1}{{( \frac{ν}{κ} .2427 )}^{2}} \\ μ = \frac{κ 16.97}{{ν}^{2}}$$

where μ=general formula for reduced mass.

We now look for the difference in molecular weight (amu) among a metal (M), boron (B) and H or D.

For H: M^{-x}[B(H)_{y}]ₓ

For D: M^{-x}[D(H)_{y}]ₓ

$$μ = \frac{Hx ( M + ( x + 1 ) ( B + YH ) + B + ( Y - 1 ) H )}{Hx ( M + ( x + 1 ) ( B + YH ) + B + ( Y - 1 ) H )}$$

where the numerator and the denominator are the same and =A

Thus: μH+μM+μA=HM+HA

Solve for M: μH+μA=M(H−μ)

When M>0, then H>μ

Therefore, in picking an active atom on a ligand:

$$ligand ( L ) > \frac{κ}{{ν}^{2}} 16.97$$

An alternate approach is to begin with the available laser emissions line (v) and determine what the reduced mass and, therefore, what ligand is to match.

Therefore, if the specific laser of interest has an emission frequency of approximately 800 cm⁻¹, then with a spring constant of approximately 5×10⁵, the molecular weight of the ligand would need to be at least 13.3 grams/mole. Thus, a ligand such as —BH₄ could be used. However, more specific calculations would have to be carried out to determine the specific ligand for a particular metal, as described hereinabove.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

What is claimed is:

1. A method of separating one or more isotopes of an element, comprising:
selecting a ligand for attachment to said one or more isotopes of said element;
attaching said ligand to said one or more isotopes of said element; and
separating said one or more isotopes of said element by an isotope separation technique.

2. The method of claim 1, wherein the element is a metal having a valence greater than two.

3. The method of claim 1, wherein the attachment of the ligand to said at least one isotope of said element forms a volatile, stable complex at room temperature.

4. The method of claim 1, wherein said ligand is a boron-containing compound.

5. The method of claim 4, wherein the boron-containing compound is selected from the group consisting of BH₄, BD₄, CH₃BH₃ and CD₃BD₃.

6. The method of claim 5, wherein the boron-containing compound is ionically attached to said at least one isotope of said element.

7. The method of claim 1, wherein the isotope separation technique is selected from the group consisting of centrifuges, diffusion and distillation.

8. The method of claim 1, wherein the isotope separation is effected by a molecular laser isotope separation technique.

9. The method of claim 8, wherein the ligand is selected based on its vibrational frequency so that the ligand has an absorption wavelength that is close to the emission wavelength of a laser used in the molecular laser isotope separation technique.
